(19) United States
(12) Patent Application Publication
(10) Pub. No.: US 2011/0097950 A1
(43) Pub. Date: Apr. 28, 2011

(54) POWER PLUG

(75) Inventors: CHIA-SHIN CHOU, Tu-Cheng (TW); ZHEN-XING YE, Shenzhen City (CN)

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/639,000

(22) Filed: Dec. 16, 2009

(30) Foreign Application Priority Data
Oct. 22, 2009 (CN) 200910308648.4

(51) Int. Cl. H01R 13/46

(52) U.S. Cl. 439/893

(57) ABSTRACT

A power plug includes a seat, a pair of covers, a connecting member, two contact prongs and a coil. The seat includes an operating member and a supporting member formed on the operating member. The pair of covers are rotatably connected to opposite sides of the supporting member of the seat, respectively. The connecting member is rotatably connected to the supporting member and located between the pair of covers. The two contact prongs are fixed on the seat. The coil has two ends respectively abutting bottom sides of the pair of covers to exert an upward force to each cover.

### BACKGROUND

1. Technical Field

The present disclosure relates generally to power plugs, and particularly to a power plug with an enhanced security.

2. Description of Related Art

For some old pieces of equipment, their power plugs may not be up to today's safety standards, thus putting their users in danger when dealing with power connections using those old plugs.

What is need, therefore, is a power plug which can overcome the above limitations.

### BRIEF DESCRIPTION OF THE DRAWINGS

FIG. 1 is an isometric, assembled view of a power plug according to an exemplary embodiment.

FIG. 2 is an exploded view of the power plug of FIG. 1.

FIG. 3 shows the power plug of FIG. 1 with covers thereof folded.

### DETAILED DESCRIPTION

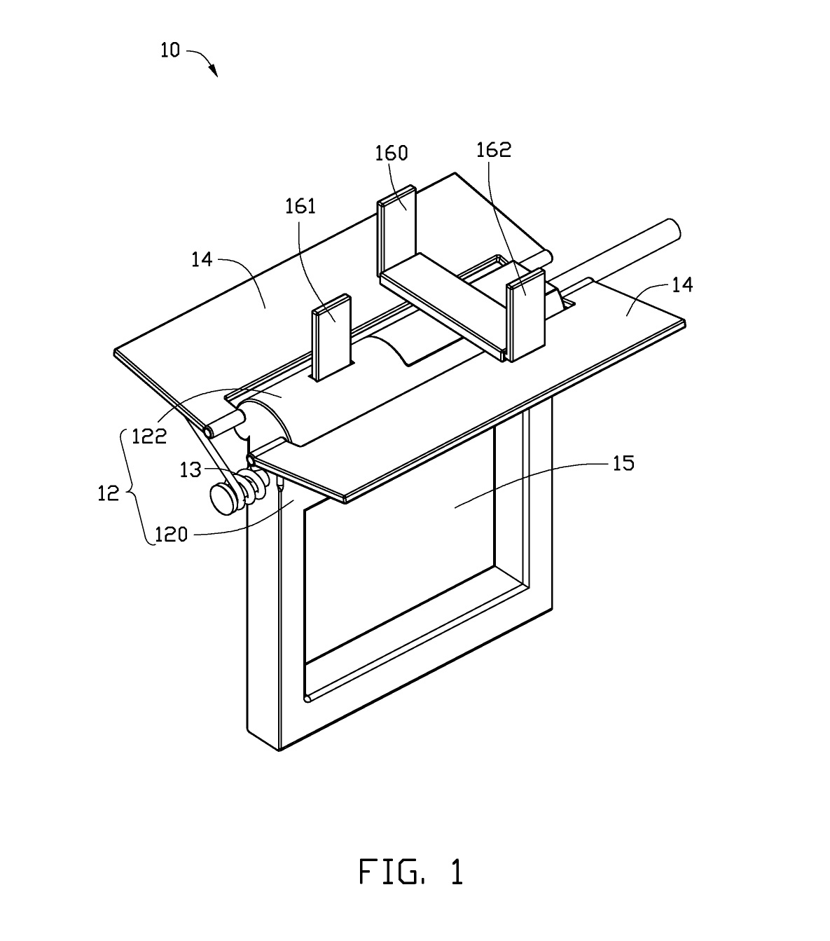

Referring to FIG. 1, a power plug according to an exemplary embodiment includes a seat 12, a pair of covers 14, and three contact prongs 161, 160 and 162. As seen in FIG. 1, the covers 14 can be unfolded to act as a shield to protect a user from contacting the contact prongs 161, 160 and 162 and thus avoid electrical shock.

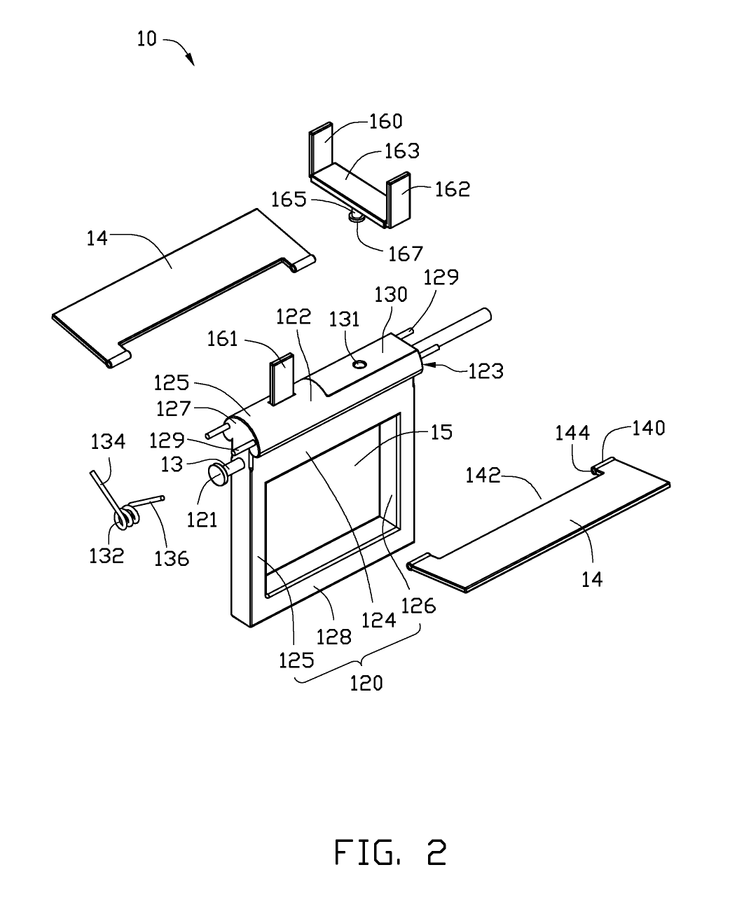

Referring to FIG. 2, the seat 12 is made of electrically insulating materials, such as plastic. The seat 12 includes an operating member 120, and a supporting member 122 formed on the operating member 120.

The operating member 120 of the seat 12 is rectangular and hollow. The operating member 120 includes a top bar 124, a bottom bar 128 parallel to the top bar 124, a left bar 125 interconnecting left ends of the top bar 124 and the bottom bar 128, and a right bar 126 interconnecting right ends of the top bar 124 and the bottom bar 128. An opening 15 is defined among the top bar 124, the bottom bar 128, the left bar 125, and the right bar 126 for facilitating connecting/disconnecting the power plug 10 to/from a matching socket (not shown).

A rod 13 extends outward from the left bar 125 of the operating member 120 at a position adjacent to a junction of the top bar 124 and the left bar 125. The rod 13 is substantially perpendicular to the left bar 125, and is substantially parallel to the top bar 124. A head 121 is formed at a free end of the rod 13 with a diameter larger than that of the rod 13. A coil 132 is mounted around the rod 13, and is kept from escaping from the rod 13 by the head 121. The coil 132 has two ends 134 and 136 extending upward aslant along opposite directions. That is, the two ends 134 and 136 of the coil 132 are located over the rod 13 and at opposite sides of the rod 13. An angle between the ends 134 and 136 of the coil 132 can be enlarged when the ends 134 and 136 of the coil 132 undergo a downward force.

The supporting member 122 of the seat 12 is formed on the top bar 124 of the operating member 120. The supporting member 122 is elongated, and is substantially semi-columnar in profile. The supporting member 122 includes an elongated top surface, a first end surface 127 and a second end surface 123. A cutout is formed at a top of a right side of the supporting member 122. Thus the top surface of the supporting member 122 has a convex left portion 125 and a planar right portion 130. An engaging hole 131 is defined in a middle of the planar right portion 130 of the top surface of the supporting member 122.

A pair of shafts 129 extend outward from the first end surface 127, and another pair of shafts 129 extend outward from the second end surface 123 of the supporting member 122. The pair of shafts 129 on each end surface 127, 123 are parallel to each other, and substantially at the same level. Each shaft 129 on the first end surface 127 is collinear with one shaft 129 on the second end surface 123. The two shafts 129 at the first end surface 127 of the supporting member 122 are located over the rod 13, and are symmetrical relative to the rod 13. Cooperatively the shafts 129 at the first end surface 127 and the rod 13 generally define an isosceles triangle.

The pair of covers 14 are identical to each other. Similar to the seat 12, the two covers 14 are made of electrically insulating materials. Each cover 14 is a flat sheet plate which is longer than the supporting member 122 but approximately equals to a sum of the lengths of the supporting member 122 and the shafts 129 at two end surfaces 127, 123 of the supporting member 122. An aperture 142 is defined at a lateral edge of each cover 14. The apertures 142 cooperate to accommodate the supporting member 122. A connecting portion 140 is formed at each end of each aperture 142. A through hole 144 is defined along a central longitudinal axis of each connecting portion 140. The through hole 144 is at least as wide as the shaft 129.

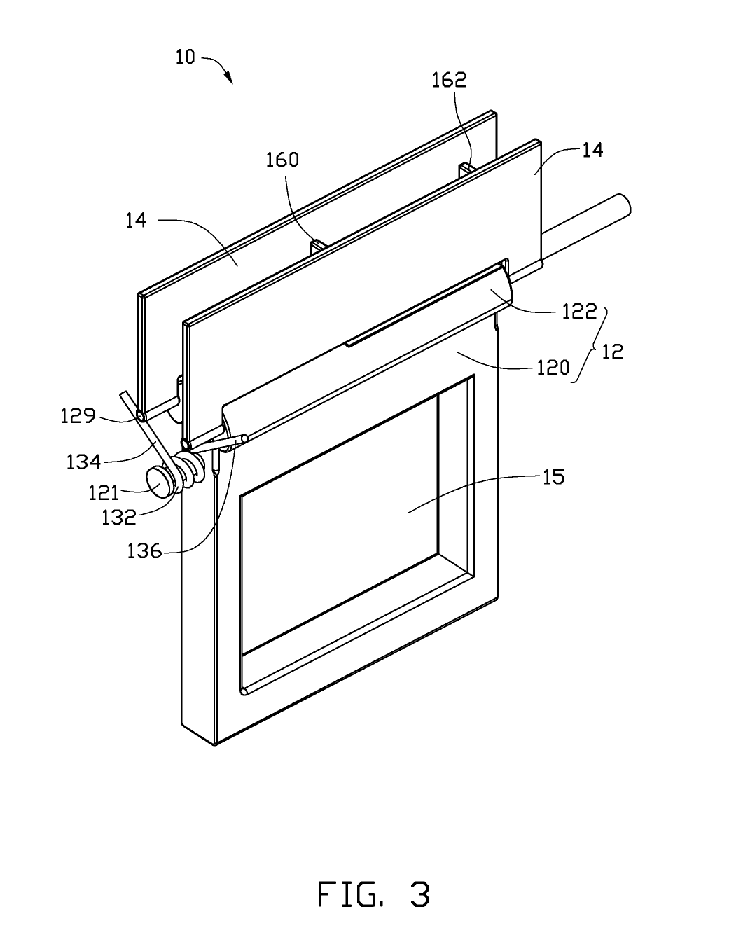

When assembled, the two covers 14 are arranged at two opposite sides of the supporting member 122 with the lateral edges adjacent to the supporting member 122. The shafts 129 of the supporting member 122 engage in the through holes 144 of the connecting portions 140 of the two covers 14, respectively. Thus the two covers 14 are rotatably connected to the supporting member 122, and are symmetrically arranged relative to the supporting member 122. The two covers 14 are located over the coil 132 and respectively engaged with the two ends 134 and 136 of the coil 132. As shown in FIG. 3, when the covers 14 are rotated to be vertical, the two covers 14 are parallel to each other with the lateral edges thereof at a bottom and abutting the two ends 134 and 136 of the coil 132. As shown in FIG. 1, when the covers 14 are rotated to be substantially horizontal, the angle between the ends 134 and 136 of the coil 132 is enlarged and each end 134, 136 of the coil 132 abuts a corresponding cover 14 at a middle portion.

The three contact prongs, i.e., first contact prong 161, second contact prong 160 and third contact prong 162, are conductive and perpendicular to the supporting member 122. Distal ends of the three contact prongs 161, 160, 162 are substantially at the same level, but slightly lower than tops of the two covers 14 when the covers 14 are rotated to be vertical (as shown in FIG. 3). The first contact prong 161 extends perpendicularly and upward from a middle of the convex left portion 125 of the top surface of the supporting member 122. The first contact prong 161 is fixed to the convex left portion 125 of the top surface, and is electrically connected to the wires which extend outward from the supporting member 122 through the second end surface 123.

The second contact prong 160 and the third contact prong 162 are connected together by a connecting member 163. The connecting member 163 is electrically insulating, and has a shape and a size substantially the same as those of the planar right portion 130 of the top surface of the supporting member 122. A connector 165 extends downward from a middle of the connecting member 163. The connector 165 has an outer diameter slightly smaller than a diameter of the engaging hole 131 of the supporting member 122. An engaging head 167 is formed at a bottom of the connector 165 with an outer diameter larger than the diameter of the engaging hole 131 of the supporting member 122. The second contact prong 160 and the third contact prong 162 are fixed at opposite ends 134 and 136 of the connecting member 163.

When assembled, the connector 165 extends through the engaging hole 131 of the supporting member 122 with the engaging head 167 limited in the supporting member 122 to abut a bottom of the planar right portion 130 of the top surface. Thus the connecting member 163 with the second contact prong 160 and the third contact prong 162 fixed thereon is rotatably connected to the supporting member 122. Further, the second contact prong 160 and the third contact prong 162 are electrically connected to the wires, which is not shown in the drawings for simplifying the drawings.

To use the power plug 10, referring to FIG. 1 again, the covers 14 are spread open manually and the connecting member 163 is grasped and rotated about 90 degrees. In this position, the connecting member 163 holds the two covers 14 in the open position. Simultaneously, the outward rotation of the covers 14 causes the ends 134 and 136 of the coil 132 to deform and thus an upward force is put on the each cover 14 by the corresponding deformed end 134 or 136 of the coil 132. Thus the two covers 14 are held still under the upward force of the coil 132 and the downward force of the connecting member 163. In this state, the three contact prongs 161, 160, and 162 cooperatively define a triangle, and thus can be easily inserted into the slots of a conventional socket.

Furthermore, when the power plug 10 is not needed, the connecting member 163 can be rotated until the entirely connecting member 163 onto the planar right portion 130 of the top surface of the supporting member 122. In such a state, referring to FIG. 3, the entirely connecting member 163 is on the right portion 130 of the top surface. The three contact prongs 161, 160, 162 are collinear. The downward force on the covers 14 in the using state of the power plug 10 is inexistent, and the upward force of the coil 132 causes the covers 14 to rotate inwardly to be vertical. Thus the three contact prongs 161, 160, 162 are located between the covers 14 and are lower than tops of the covers 14.

For the present power plug 10, when in use, the covers 14 of the present power plug 10 protect the user from contact with conductive metal, such as the contact prongs 161, 160, 162. When not in use, the connecting member 163 is rotated back and the covers 14 fold up for a compact plug 10. Accordingly, injury or death of the user by electric shock during connecting or disconnecting the power plug 10 is avoided. Further, when the power plug 10 is not in use and is folded, the contact prongs 161, 160, 162 are protected from being damage, and a volume of the power plug 10 is reduced. Accordingly, the present power plug 10 is convenient to pack and transport, particularly to the manufacturer.

It is to be understood, however, that even though numerous characteristics and advantages of embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

1. A power plug, comprising:
a seat;
two contact prongs arranged on the seat; and
a pair of covers being rotatably connected to opposite sides of the seat, the contact prongs located between the pair of covers.

2. The power plug of claim 1, further comprising a coil fixed on the seat, the coil having two ends respectively abutting the pair of covers to exert the covers rotating to rotate towards each other.

3. The power plug of claim 2, wherein the two contact prongs are fixed at opposite ends of a connecting member, the connecting member being electrically insulating, a connector extending from a middle of the connecting member and rotatably engaging in the seat.

4. The power plug of claim 3, wherein the seat defines an engaging hole therein, the connector having a diameter not larger than that of the engaging hole, an engaging head formed at a distal end of the connector with a diameter larger than that of the engaging hole, the connector extending through the engaging hole with the engaging head being limited in the seat.

5. The power plug of claim 4, wherein the opposite ends of the connecting member respectively abut the covers when the connecting member is rotated to a first position relative to the seat to cause the covers to rotate outward from each other.

6. The power plug of claim 5, wherein the seat forms a planar surface, the engaging hole being defined in a middle of the planar surface, a size and a shape of the connecting member being the same as those of the planar surface; and wherein the covers are substantially parallel to each other when the entire connecting member is rotated to a second position relative to the seat on the planar surface of the seat.

7. The power plug of claim 6, further comprising a third contact prong fixed on the seat, the third contact prong being collinear with the two contact prongs when the entire connecting member is rotated to the second position, and the third contact prong and the two contact prongs cooperatively defining a triangle when the connecting member is rotated to the first position.

8. The power plug of claim 7, wherein the seat comprises an operating member and a supporting member formed on the operating member, the another contact prong and the two contact prongs are formed at a top surface of the supporting member, and the pair of covers are connected to two opposite end surfaces of the operating member.

9. The power plug of claim 8, wherein each end surface of the supporting member has a pair of shafts extending outward, each cover defining a pair of through holes with corresponding shafts extending therethrough to connect the cover onto the operating member.

10. The power plug of claim 8, wherein the operating member is rectangular and hollow.

11. The power plug of claim 8, wherein a rod extends outward from the operating member, and the coil is mounted around the rod.

12. A power plug, comprising:
a seat comprising an operating member and a supporting member formed on the operating member;
a pair of covers being rotatably connected to opposite sides of the supporting member of the seat, respectively;
a connecting member being rotatably connected to the supporting member and located between the pair of covers, the connecting member being electrically insulating;
two contact prongs being fixed at opposite ends of the connecting member; and
a coil having two ends respectively abutting bottom sides of the pair of covers to exert an upward force to each cover.

13. The power plug of claim 12, wherein when the connecting member is rotated to a first position relative to the supporting member, the opposite ends of the connecting member respectively abut top sides of the covers to put a downward force on each cover to balance the upward force of the coil.

14. The power plug of claim 12, wherein when the connecting member is rotated to a second position relative to the supporting member, the pair of covers are rotated to be substantially parallel to each other by the upward force of the coil, and distal ends of the two contact prongs are lower than top edges of the covers when the pair of covers are parallel to each other.

15. The power plug of claim 12, wherein the supporting member defines an engaging hole therein, and the connecting member has a connector extending downward in the engaging hole, an engaging head with a diameter larger than the engaging hole formed at a bottom of the connector and limited in the supporting member.

16. The power plug of claim 12, further comprising a third contact prong fixed on the supporting member, the third contact prong being collinear with the two contact prongs when the connecting member is rotated to the second position, and the third contact prong and the two contact prongs cooperatively defining a triangle when the connecting member is rotated to the first position.

17. The power plug of claim 12, wherein the supporting member comprises a top surface and two end surfaces, the connecting member is arranged on the top surface, and a pair of shafts are formed on each end surface and rotatably extend through the covers to connect the covers onto the supporting member.

18. The power plug of claim 12, wherein a rod extends outward from the operating member at a position adjacent to the supporting member, the pair of shafts of the corresponding end surface of the operating member are symmetrical relative to the rod, and the coil is mounted around the rod.

19. The power plug of claim 12, wherein the supporting member forms a planar surface with a size and a shape being the same as those of the connecting member, an engaging hole being defined in the supporting member and engagingly receiving the connecting member.
